(19) United States
(12) Patent Application Publication
(10) Pub. No.: US 2013/0141652 A1
(43) Pub. Date: Jun. 6, 2013

(54) ILLUMINATING DEVICE, DISPLAY DEVICE, LIQUID CRYSTAL DISPLAY DEVICE, AND TELEVISION RECEIVING DEVICE

(71) Applicant: Yasumori Kuromizu, Osaka-shi (JP)

(72) Inventor: Yasumori Kuromizu, Osaka-shi (JP)

(21) Appl. No.: 13/816,769

(22) PCT Filed: May 19, 2011
(86) PCT No.: PCT/JP2011/061570

§ 371 Date: Feb. 13, 2013

(30) Foreign Application Priority Data
Aug. 20, 2010 (JP) JP 2010-185053

(51) Int. Cl. F21V 23/00; H04N 5/66; G02F 1/1335

(52) U.S. Cl. CPC F21V 23/001; G02F 1/133615; H04N 5/66
USPC 348/790; 362/633; 362/612; 349/61

(57) ABSTRACT

An adverse effect of noise and the amount of electric wires are decreased by reducing the length of power supply lines arranged to supply electric power to light sources. An illuminating device (20) includes a chassis plate (22) having a square shape in a plan view, edge light type light sources (28) disposed along at least two opposing side faces of the chassis plate, power supply means (30) arranged to supply electric power to the light sources, and power supply lines (32) arranged to electrically connect the light sources and the power supply means, wherein one ends of the power supply lines are in connection with the power supply means at a substantial center of the chassis plate.

### TECHNICAL FIELD

The present invention relates to a liquid crystal display device including a so-called edge light type illuminating device, an edge light type illuminating device, and a television receiving device including the liquid crystal display device or the illuminating device.

### BACKGROUND ART

A liquid crystal display device including a transmissive liquid crystal display panel includes an illuminating device arranged to project light onto the liquid crystal display panel. The illuminating device includes, as a light source, a small fluorescent tube called a cold cathode fluorescent tube (CCFL), or a light emitting diode (LED).

The basic structure of the illuminating device varies depending on the position at which the light source is disposed. A direct type illuminating device and an edge light type illuminating device are generally known. The direct type illuminating device defines an illuminating device including a light source disposed directly beneath a liquid crystal display panel. The edge light type illuminating device defines an illuminating device including a light source disposed on a side face of a liquid crystal display panel. Because the edge light type illuminating device has the configuration that the light source is disposed on the side face, a thinner profile of the edge light type illuminating device can be advantageously achieved.

A power supply board (power supply means) disposed in the liquid crystal display device is arranged to supply electric power to the light source such as LED. That is, the light source and the power supply board are electrically connected to each other via an electric wire (and a connector) that is routed in the liquid crystal display device (e.g., PTL 1). FIG. 9 is a view for illustrating a configuration of a wiring route in an edge light type illuminating device (LED light sources). In the configuration of the edge light type illuminating device shown in FIG. 9, the LED light sources are disposed along two sides (long sides) of a liquid crystal display device having a rectangular shape when seen in a plan view.

LED light sources 101 are mounted on long and thin LED boards 102 (upper LED boards 102a, lower LED boards 102b), and connected in series to each other, for example. The LED boards 102 on which the LED light sources 101 are mounted are disposed inside (along inner faces) of a chassis plate 104 having the shape of a shallow tray (the chassis plate 104 is shown simply in FIG. 9). Meanwhile, a power supply board 106 is disposed outside of the chassis plate 104. Power supply lines 108 drawn from the power supply board 106 are drawn into the inside of the chassis plate 104 from a corner of the rectangular-shaped chassis plate 104 (from the lower right corner in FIG. 9). In a preferred embodiment of the present invention, copper wires are used as the power supply lines. Electric wires (two electric wires) 108a for upper LEDs among the electric wires 108 drawn into the inside of the chassis plate 104 are connected to both the ends of the upper LED boards 102a (the positive side and the negative side of the LED light sources 101 disposed on an upper side face of the chassis plate 104). In addition, one of two electric wires 108b for lower LEDs is directly connected to the right end of the lower LED boards 102b (the negative (positive) side of the LED light sources 101 disposed on a lower side face of the chassis plate 104), and the other electric wire 108b for lower LEDs goes around to be routed through an upper portion of the chassis plate 104 (i.e., through the side where the upper LED boards 102a are disposed) to be connected to the left end of the lower LED boards 102b (the positive (negative) side of the LED light sources 101 disposed on the lower side face of the chassis plate 104).

The reasons why one of the two electric wires 108b for lower LEDs goes around to be routed through the upper portion of the chassis plate 104 are cited below: 1) being routed part of the way on the same route as the electric wires 108a for upper LEDs, the one of the two electric wires 108b for lower LEDs can be tied with the electric wires 108a for upper LEDs, which can save space for housing the power supply lines 108; and 2) an adverse effect of noise caused by the power supply lines 108 (i.e., electromagnetic interference (EMI)) can be prevented from being exercised on source boards arranged to supply source signals to a liquid crystal display panel, the source boards being often disposed at a lower portion of a liquid crystal display device.

### CITATION LIST

### Patent Literature

PTL 1: JP 2007-256763

### SUMMARY OF INVENTION

### Technical Problem

However, because the power supply lines are long in the liquid crystal display device having the configuration of the wiring route shown in FIG. 9, there arises a problem that an adverse effect of noise (unnecessary radiation) caused by or exercised on the power supply lines is significantly produced. For this reason, the cost of noise prevention rises.

In addition, if a large liquid crystal display device is used, the amount of electric wires, which are needed in going around to be routed, increases to cause a problem that the cost of the power supply lines themselves rises.

An object of the present invention is to provide a liquid crystal display device, an illuminating device, and a television receiving device, in which an adverse effect of noise and the amount of electric wires are decreased by reducing the length of a power supply line that is arranged to supply electric power to a light source.

### Solution to Problem

To achieve the objects and in accordance with the purpose of the present invention, a liquid crystal display device of the present invention includes a chassis plate having a square shape when seen in a plan view, a light source that is disposed along a side face of the chassis plate, power supply means arranged to supply electric power to the light source, and a connecting connector arranged to electrically connect the power supply means and the light source, wherein the connecting connector is disposed at a substantial center of the chassis plate.

In this case, it is preferable that a power supply line is further included, one end of which being in connection with the connecting connector.

It is preferable that a through-hole disposed at the substantial center of the chassis plate is further included, that the light source and the power supply line are disposed on a front side of the chassis plate, that the power supply means arranged to supply electric power to the light source includes the connecting connector, and is disposed on a back side of the chassis plate, and that the one end of the power supply line is through the through-hole to be in electrical connection with the power supply means via the connecting connector.

In addition, it is preferable that the chassis plate includes a concave portion having the shape of being dented to a face of the chassis plate, the face being opposite to a face on which the light source is disposed, and the power supply line is housed in the concave portion.

In addition, it is preferable that the light source defines a plurality of LED light sources mounted on each of LED boards that are disposed along two opposing side faces of the chassis plate, that the illuminating device further includes power supply connectors that are each mounted on the LED boards, each of the power supply connectors including a positive terminal that is in electrical connection with a positive electrode of the LED light sources, and a negative terminal that is in electrical connection with a negative electrode of the LED light sources, and that the other ends of the power supply lines are in connection with the power supply connectors.

In addition, it is preferable that the two LED boards on each of which the plurality of LED light sources are mounted are disposed along an upper side face of the chassis plate, and the two LED boards on each of which the plurality of LED light sources are mounted are disposed are disposed along a lower side face of the chassis plate, and that in the LED boards disposed on the right as facing the chassis plate, the power supply connectors are disposed at left ends of the LED boards, and in the LED boards disposed on the left as facing the chassis plate, the power supply connectors are disposed at right ends of the LED boards.

In addition, it is preferable that if the one end of the power supply line is through the through-hole disposed at the substantial center of the chassis plate to be in electrical connection with the power supply means via the connecting connector, the connecting connector includes a connector housing, of which an outer surface has a light color.

In addition, it is preferable that the power supply line defines a copper wire.

In addition, it is preferable that the power supply line defines copper foil.

Meanwhile, it is preferable that the power supply means defines a flexible board. Alternatively, it is preferable that the power supply means defines a glass epoxy board, a phenolic paper board, or an aluminum board.

In another aspect of the present invention, a display device of the present invention includes the illuminating device described above, and a display panel arranged to receive light emitted from the illuminating device.

In this case, it is preferable that the display device defines a liquid crystal display device, and the display panel defines a liquid crystal display panel.

In another aspect of the present invention, a television receiving device includes the display device or the liquid crystal display device described above.

### Advantageous Effects of Invention

Because the display device, the illuminating device and the television receiving device of the present invention have the configuration that the connecting connector of the power supply means is disposed at the substantial center of the chassis plate (on a back side face of a substantial center of a liquid crystal display device 10), the length of the power supply line arranged to connect the power supply means and the light source (the length of a wiring route) can be reduced compared with a conventional display device, illuminating device and television receiving device. Thus, the reduced length of the power supply line can decrease an adverse effect of noise (unnecessary radiation) caused by or exercised on the power supply line (can decrease the cost of noise prevention). In addition, the reduced length of the power supply line can decrease the amount of used power supply line.

With the configuration that the light source and the power supply line are disposed on the front side of the chassis plate while that the power supply means is disposed on the back side of the chassis plate, providing the through-hole at the substantial center of the chassis plate allows the one end of the power supply line and the power supply means to be connected via the through-hole.

In addition, with the configuration that the power supply line is housed in the concave portion dented to the back side of the chassis plate, optical members (e.g., a reflection sheet and a light guide plate) that are included in the illuminating device can be prevented from being disturbed by the power supply line in terms of layout.

In addition, with the configuration that the power supply connectors are provided, which include the positive terminals that are in electrical connection with the positive electrodes of the LED light sources and the negative terminals that are in electrical connection with the negative electrodes of the LED light sources, the positive side electric wires and the negative side electric wires can be made equal in length (or, each of the pairs can be made of one 2-conductor wire). This configuration allows the kinds of the components (power supply lines) to be reduced.

With the configuration that two LED boards are disposed along each of the upper side and lower side faces of the chassis plate, all the LED boards being the same in size, and the power supply connectors are disposed at the left ends of the LED boards in the LED boards disposed on the right as facing the chassis plate while the power supply connectors are disposed at the right ends of the LED boards in the LED boards disposed on the left as facing the chassis plate, the distances (shortest distances) of the LED boards and the power supply means (an output port of the power supply means) are equal to one another. Thus, the power supply lines arranged to connect the LED boards and the power supply means can be made equal in length. This configuration allows the kinds of the components (power supply lines) to be unified and reduced, while a conventional display device includes components of various kinds.

In addition, in the configuration that the one end of the power supply line is through the through-hole disposed at the substantial center of the chassis plate to be in electrical connection with the power supply means via the connecting connector, if the outer surface of the connector housing has a light color, the luminance of the substantial center of the chassis plate can be prevented from decreasing because of the shadow of the connecting connector (display unevenness can be prevented).

If the power supply line defines the copper wire, the copper wire has the advantage of superior workability during wiring work. Alternatively, if the power supply line defines the copper foil, the wiring route can advantageously have a shortest distance without concern for disconnection because of distortion or deformation of wires.

If the power supply means defines the flexible board, it has the advantage of superior workability during assembly work. If the power supply means defines the glass epoxy board, it has the advantage of allowing a layout of a double-sided board. If the power supply means defines the phenolic paper board, it has the advantage of achieving a low cost board. Alternatively, the aluminum board is preferably used.

### BRIEF DESCRIPTION OF DRAWINGS

FIG. 1 is an exploded perspective view showing a liquid crystal display device of a preferred embodiment of the present invention.

FIG. 2 is an enlarged cross-sectional view showing the liquid crystal display device shown in FIG. 1.

FIG. 3 is a view showing a schematic configuration on LED boards included in the liquid crystal display device shown in FIG. 1.

FIG. 4 is a schematic view for illustrating a connecting structure between LED light sources and a power supply board with the use of power supply lines.

FIG. 5 is a simplified cross-sectional view showing an illuminating device along the line A-A of FIG. 4.

FIG. 6 is a schematic view for illustrating a connecting structure between LED light sources and a power supply board of a first modification.

FIG. 7 is a schematic view for illustrating a connecting structure between LED light sources and a power supply board of a second modification.

FIG. 8 is an exploded perspective view showing a television receiving device of a preferred embodiment of the present invention.

FIG. 9 is a view showing a configuration of a wiring route in a conventional liquid crystal display device.

### DESCRIPTION OF EMBODIMENTS

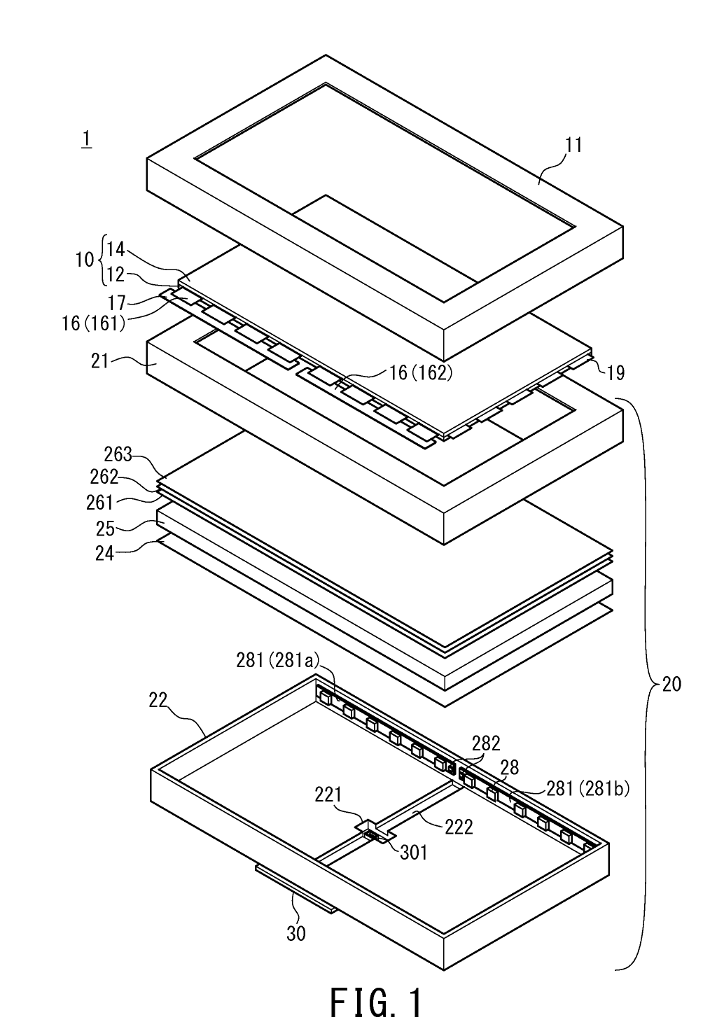

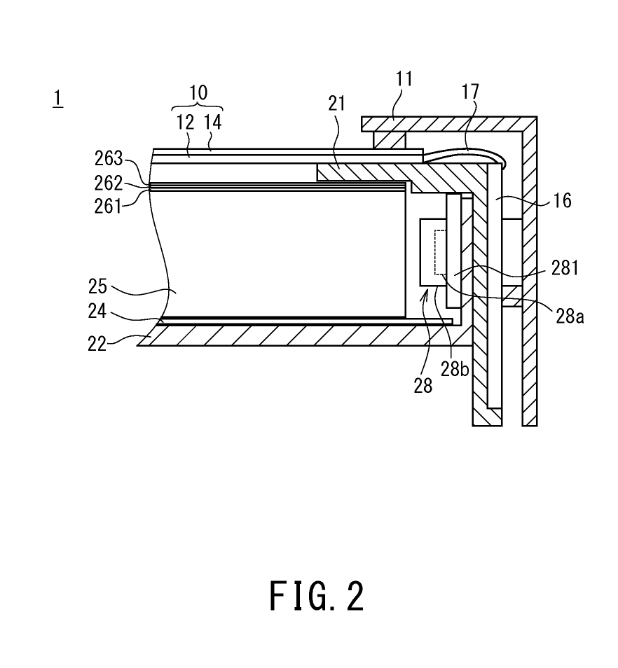

A detailed description of a preferred embodiment of the present invention will now be provided with reference to the accompanying drawings. FIG. 1 is an exploded perspective view showing a liquid crystal display device 1 of a preferred embodiment of the present invention. FIG. 2 is an enlarged cross-sectional view showing the liquid crystal display device 1. In the following descriptions, unless otherwise noted, a front side of the liquid crystal display device 1 refers to the tops of FIGS. 1 and 2, and a back side of the liquid crystal display device 1 refers to the bottoms of FIGS. 1 and 2. In addition, a right side, a left side, an upper side, and a lower side of the liquid crystal display device 1 refer to the sides of the liquid crystal display device 1 when the liquid crystal display device 1 (a liquid crystal display panel 10) is seen from an anterior view. In FIGS. 1 and 2, power supply lines 32 for LED light sources 28 are not illustrated.

The liquid crystal display device 1 of the present embodiment includes the liquid crystal display panel 10 and an illuminating device 20. The liquid crystal display panel 10 includes a thin film transistor (TFT) array substrate 12 (hereinafter, referred to simply as the array substrate 12) and a color filter (CF) substrate 14, and is fixed by a bezel 11 having a frame shape. The array substrate 12 and the color filter substrate 14 are opposed to each other having a given cell gap therebetween, in which liquid crystals are filled.

The array substrate 12 defines a glass substrate on which TFTs and pixel electrodes are arranged in a matrix. The color filter substrate 14 defines a glass substrate same in size as the array substrate 12, on which a plurality of color filters are arranged in a matrix, and over the entire surface of which a transparent common electrode is formed. By varying a voltage applied to the pixel electrodes and the common electrode, alignment of the liquid crystals is controlled.

Source boards 16 and a source driver 17 that are arranged to supply source signals are disposed along a lower side face of the liquid crystal display panel 10. The source boards 16 are mechanically and electrically connected to the liquid crystal display panel 10 via the source driver 17 that defines a flexible substrate. In addition, gate drives 19 that are arranged to supply gate signals are disposed on a right side face of the liquid crystal display panel 10. In the present embodiment, no gate substrate is provided.

The illuminating device 20 (an illuminating device of a preferred embodiment of the present invention) is disposed on a back side face of the liquid crystal display panel 10. The illuminating device 20 of the present embodiment defines an LED backlight including the LED light sources 28 as its light sources. The LED light sources 28 are disposed along two opposing side faces of the liquid crystal display panel 10 (along two opposing side faces of a chassis plate 22 to be described later). That is, the illuminating device 20 defines a so-called “edge light type” illuminating device.

The illuminating device 20 includes a frame 21, the chassis plate 22, a reflection sheet 24, a light guide plate 25, optical sheets 261, 262, 263, the LED light sources 28, and a power supply board 30 as shown in FIGS. 1 and 2.

The frame 21 has a rectangular frame shape, where the sides which form the frame have the shape of the letter “L” in cross section. The frame 21 is arranged to hold the reflection sheet 24, the light guide plate 25, and the optical sheets 261, 262, 263, which are stacked on the chassis plate 22, inside of the chassis plate 22. That is, the reflection sheet 24, the light guide plate 25, and the optical sheets 261, 262, 263 are disposed in a space formed by the frame 21 and the chassis plate 22 as shown in FIG. 2.

The chassis plate 22 is made from aluminum or an aluminum alloy, and has the shape of a box of low height, which is square when seen in a plan view. The LED light sources 28 mounted on LED boards 281 are disposed on inside faces of the chassis plate 22. To be specific, the LED light sources 28 are arranged to project light from lateral sides of the chassis plate 22 toward the center of the chassis plate 22. The reflection sheet 24 is laid on an inner bottom face of the chassis plate 22, and the light guide plate 25 is disposed on the reflection sheet 24. The optical sheets 261, 262, 263 are disposed on the light guide plate 25. Thus, as described above, the reflection sheet 24, the light guide plate 25, and the optical sheets 261, 262, 263 are disposed in the space formed by the frame 21 and the chassis plate 22.

The reflection sheet 24 is arranged to efficiently reflect the light that is emitted from the lateral sides of the chassis plate 22 by the LED light sources 28 toward the liquid crystal display panel 10. The light guide plate on the reflection sheet 24 is arranged to planarly diffuse the light reflected by the reflection sheet 24. Using the reflection sheet 24 and the light guide plate can enhance the luminance of light that is emitted from the light sources disposed along the lateral side faces of the chassis plate 22 (the liquid crystal display panel 10) (edge light) and reaches the panel surface, and allows uniformalization of the luminance in a plane direction of the liquid crystal display panel 10.

The optical sheets 261, 262, 263 define thin resin sheets having a rectangular shape when seen in a plan view. The optical sheets 261, 262, 263 are used in combination, and the combination can be selected as appropriate in accordance with the properties required of the liquid crystal display device 1. Specific combinations of the optical sheets 261, 262, 263 include a combination of the diffusion sheet 261, the lens sheet 262 and the reflection sheet 263, which are disposed in this order from the bottom. The diffusion sheet 261 allows further uniformalization of the luminance in the plane direction of the light that reaches the liquid crystal display panel 10. The lens sheet 262 is arranged to gather the light that has passed through the diffusion sheet 261 to allow enhancement of the luminance of the light. The reflection sheet 263 is arranged to transmit polarized light in a given direction (light that is polarized in a given direction) while reflecting polarized light other than the polarized light in the given direction so that the light that has reached the liquid crystal display panel 10 is not absorbed by a polarizing plate attached on a photo-receiving face (a lower face) of the liquid crystal display panel 10.

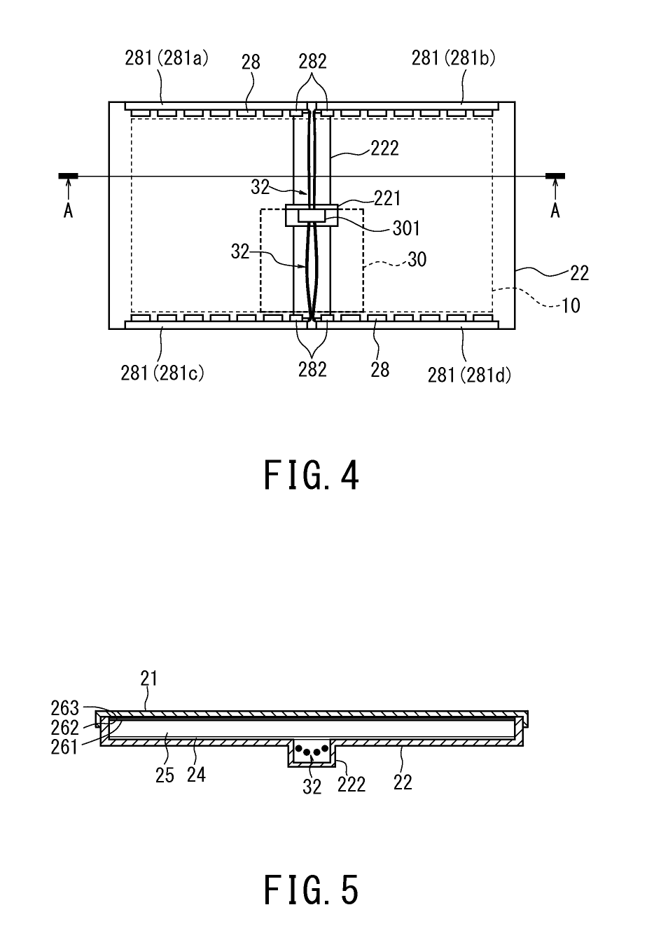

The LED light sources 28 are disposed along the two opposing side faces of the chassis plate 22. To be specific, the plurality of LED boards 281 are disposed on the inside faces of the chassis plate 22. The plurality of the LED light sources 28 are linearly mounted in a longitudinal direction on each LED board 281. Thus, the LED light sources 28 are disposed along the two opposing side faces of the chassis plate 22, that is, along the two opposing side faces of the liquid crystal display panel 10 disposed in front of the illuminating device (see FIG. 4 to be described later).

In the present embodiment, four LED boards 281 are disposed, of which two LED boards 281 are disposed along the upper side face of the chassis plate 22, and two LED boards 281 are disposed along the lower side face of the chassis plate 22. The four LED boards 281 are same in size, and disposed so as to be horizontally symmetrical with respect to center lines to bisect the chassis plate 22 (the liquid crystal display panel 10) (center lines to horizontally and vertically bisect the chassis plate 22). The LED light sources 28 mounted on one LED board 281 are same in number as LED light sources 28 mounted on another LED board 281. Hereinafter, in order to distinguish the LED boards 281, the LED board 281 that is disposed along the upper side face of the chassis plate 22 on the left as facing the liquid crystal display panel is sometimes referred to as an upper left LED board 281a. The LED board 281 that is disposed along the upper side face of the chassis plate 22 on the right as facing the liquid crystal display panel 10 is sometimes referred to as an upper right LED board 281b. The LED board 281 that is disposed along the lower side face of the chassis plate 22 on the left as facing the liquid crystal display panel 10 is sometimes referred to as a lower left LED board 281c. The LED board 281 that is disposed along the lower side face of the chassis plate 22 on the right as facing the liquid crystal display panel 10 is sometimes referred to as a lower right LED board 281d.

The LED light sources 28 define so-called white LEDs arranged to emit white light. A variety of white LEDs are known, and the white LEDs used in the present embodiment are not limited specifically. For example, a while LED is used, which has a configuration such that an LED chip 28a arranged to emit blue light is sealed with a transparent resin 28b containing a yellow fluorescent material as shown in FIG. 2

Wiring patterns arranged to supply electric power to the mounted LED light sources 28 are formed on the LED boards 281. In the present embodiment, the LED light sources 28 mounted on each LED board 281 are connected in series to each other by the wiring patterns. In addition, a power supply connector 282 is disposed at an inside end portion of each of the four LED boards 281.

To be specific, the power supply connectors 282 are disposed at positions sandwiching the space between the two adjoining LED boards 281 disposed along one side face of the chassis plate 22. The power supply connectors 282 are disposed at the right ends of the LED boards 281a and 281c that are disposed on the left as facing the liquid crystal display panel 10. The power supply connectors 282 are disposed at the left ends of the LED boards 281b and 281d that are disposed on the right as facing the liquid crystal display panel 10. That is, the power supply connectors 282 are disposed in substantial middles of the side faces of the chassis plate 22. The substantial middle defines the vicinity of an intersection of one side of the chassis plate 22 (the side where the LED light sources 28 are disposed) and a straight line to bisect the chassis plate 22.

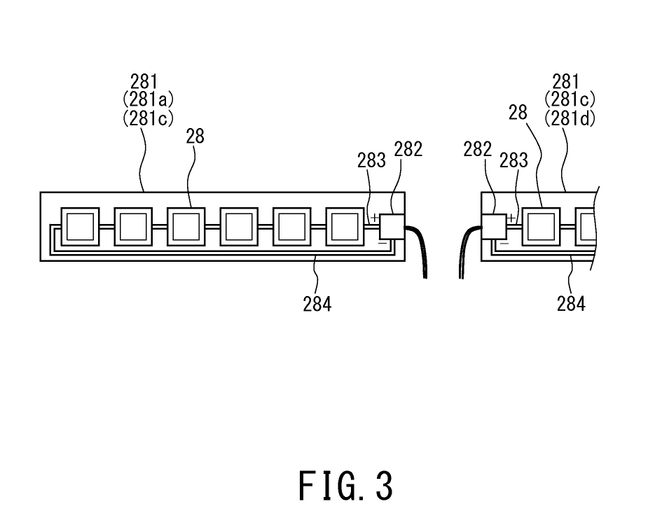

FIG. 3 is a view showing a schematic configuration on the LED boards 281 including the power supply connectors 282. The LED light sources 28 are connected in series to each other by the wiring patterns formed on the LED boards 281 as shown in FIG. 3. A positive wire 283 that is connected to a positive electrode of the LED light sources 28 is connected to a positive terminal (not illustrated) of each power supply connector 282, while a negative wire 284 that is connected to a negative electrode of the LED light sources 28 is connected to a negative terminal (not illustrated) of each power supply connector 282. In each power supply connector 282, these positive and negative terminals are fixed to a connector housing. In other words, a positive and negative connector is provided on each LED board 281.

The LED light sources 28 are electrically connected via the power supply connectors 282 to the power supply board 30 disposed behind the chassis plate 22 (the power supply board 30 corresponds to power supply means in the present invention). The power supply board 30 includes an LED control unit made up from an IC chip and other components. The LED control unit is arranged to on/off control the LED light sources 28.

A flexible board, a glass epoxy board, a phenolic paper board, or an aluminum board is preferably used as the power supply board 30. Using a flexible board as the power supply board 30 has the advantage of superior workability during assembly work. Using a glass epoxy board has the advantage of allowing a layout of a double-sided board. Using a phenolic paper board has the advantage of achieving a low cost board.

A control board (not illustrated) arranged to control the liquid crystal display panel 10 (TFT) is sometimes provided next to the power supply board 30 having the configuration described above.

Hereinafter, a detailed description of a connecting structure between the LED light sources 28 (the LED boards 281) and the power supply board 30 will be provided. FIG. 4 is a schematic view for illustrating the connecting structure (a schematic plan view showing the components that are seen from the front side). Only the outer shape of the liquid crystal display panel 10 disposed in front of the illuminating device 20 is shown by the dotted line in FIG. 4 in order to make this view clearly understandable. In addition, the chassis plate 22 is shown slightly larger in FIG. 4. The LED light sources 28 are electrically connected to the power supply board 30 by the power supply lines 32 as shown in FIG. 4.

A connecting connector (output port) 301 arranged to output electric power to turn on the LED light sources 28 is provided on the power supply board 30. In the connecting connector 301, an output positive terminal (not illustrated) arranged to be electrically connected to the positive sides of the LED light sources 28, and an output negative terminal (not illustrated) arranged to be electrically connected to the negative sides of the LED light sources 28 are fixed to a connector housing.

The power supply board 30 is disposed such that the connecting connector 301 is disposed closed to the back side face of the substantial center of the liquid crystal display panel 10 (an intersection of the diagonal lines of the liquid crystal display panel 10) as shown in FIG. 4. In the present embodiment, the back side face of the substantial center of the liquid crystal display panel 10 corresponds with a substantial center of the chassis plate 22. That is, the connecting connector 301 is disposed at a position such that the distances (shortest distances) of the connecting connector 301 and the LED boards 281 are equal to one another.

As described above, because the power supply board is disposed behind the chassis plate 22, the chassis plate 22 includes a through-hole 221 at the substantial center of the chassis plate 22. The connecting connector 301 juts to the front side of the chassis plate 22 through the through-hole 221.

Because the connecting connector 301 has the configuration of jutting to the front side of the chassis plate 22 through the through-hole 221, it is preferable that the outer surface of the connecting connector 301 has a light color. This is because this configuration can prevent the luminance of the substantial center of the chassis plate from decreasing because of the shadow of the connecting connector jutting to the front side of the chassis plate 22 (can prevent display unevenness).

One ends of the power supply lines 32 are connected to the connecting connector 301 disposed at the position described above. In the present embodiment, the power supply lines 32 consist of four pairs of electric wires (each pair consists of a positive side electric wire and a negative side electric wire) that correspond to the four LED boards 281. Connectors (not illustrated) that are provided at the one ends of the power supply lines 32 are connected to the connecting connector 301 on the power supply board 30, whereby electrical connection between the one ends of the power supply lines 32 and the power supply board 30 is made.

Meanwhile, the other ends of the power supply lines 32 are connected to the LED boards 281. To be specific, connectors (not illustrated) that are provided at the other ends of the paired electric wires of the power supply lines 32 are connected to the power supply connectors 282 on the LED boards 281, whereby electrical connection between the other ends of the power supply lines 32 and the LED boards 281 (i.e., the LED light sources 28) is made.

FIG. 5 is a simplified cross-sectional view showing the illuminating device 20 along the line A-A of FIG. 4. The chassis plate 22 includes a concave portion 222 on its front face (its inner bottom face), the concave portion having the shape of being dented to the back face side of the chassis plate 22. The concave portion 222 is disposed along the wiring routes of the power supply lines 32 (along a straight line connecting the power supply connectors 282 and light source connectors 322). In the present embodiment, the concave portion 222 has the shape of being along the center line to horizontally bisect the chassis plate 22. Thus, the power supply lines 32 that are connected to the power supply connectors 282 and the light source connectors 322 are housed in the concave portion 222.

As described above, the liquid crystal display device 1 of the present embodiment has the configuration that the one ends of the power supply lines 32 are connected to the power supply board 30 that defines power supply means at the substantial center of the chassis plate 22 (on the back side of the substantial center of the liquid crystal display panel 10), so that the length of the power supply lines 32 (the length of the wiring routes) can be reduced compared with a conventional display device. Thus, the reduced length of the power supply lines 32 can decrease an adverse effect of noise (unnecessary radiation) caused by or exercised on the power supply lines 32 (can decrease the cost of noise prevention). In addition, the reduced length of the power supply lines 32 can decrease the amount of the power supply lines 32 used in one liquid crystal display device.

Further, because the wiring routes of the power supply lines 32 are not along the lower side face of the liquid crystal display panel 10, an adverse effect of noise exercised on the source boards 16 can be decreased.

In addition, because the distances (shortest distances) of the connecting connector 301 and the LED boards 281 are equal to one another, the power supply lines 32 are equal in length. This configuration allows the kinds of the components to be unified and reduced, while a conventional display device includes components of various kinds.

Especially in the present embodiment, because the power supply connectors 282 that include the positive terminals electrically connected to the positive electrodes of the LED light sources 28 and the negative terminals electrically connected to the negative electrodes of the LED light sources 28 (i.e., the positive and negative connectors) are provided on the LED boards 281, the positive side electric wires and the negative side electric wires are equal in length (or, each of the pairs can be made of one 2-conductor wire). This configuration allows the kinds of the components (power supply lines 32) to be reduced.

In addition, because the power supply lines 32 are housed in the concave portion 222 of the chassis plate 22, the reflection sheet 24 and the light guide plate on the inner bottom face of the chassis plate 22 can be prevented from piggybacking onto the power supply lines 32.

Next, modifications of the liquid crystal display device 1 of the present embodiment will be described.

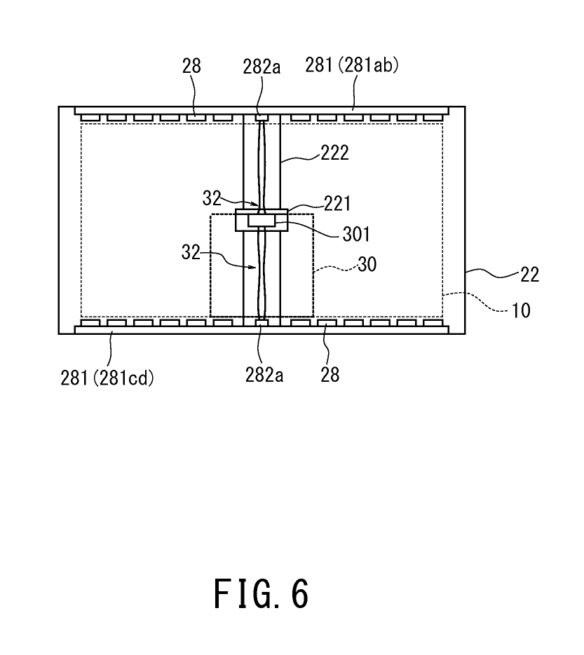

A first modification shown in FIG. 6 has a configuration such that one LED board 281 (281ab, 281cd) is disposed along each side face of a liquid crystal display panel 10. That is, the configuration of the first modification is different from the configuration of the above-described embodiment that the two LED boards 281, which are divided of one LED board, are disposed along each side face of the liquid crystal display panel 10. In the present first modification, power supply connectors 282a that include positive terminals connected to positive electrodes of LED light sources 28 and negative terminals connected to negative electrodes of the LED light sources 28 (i.e., positive and negative connectors) are provided in substantial middles of the LED boards 281. With this configuration, the length of power supply lines 32 can be reduced compared with a conventional display device as well as the above-described embodiment. Thus, the reduced length of the power supply lines 32 can decrease an adverse effect of noise caused by or exercised on the power supply lines 32. In addition, the reduced length of the power supply lines 32 can decrease the amount of the power supply lines 32 used in one liquid crystal display device.

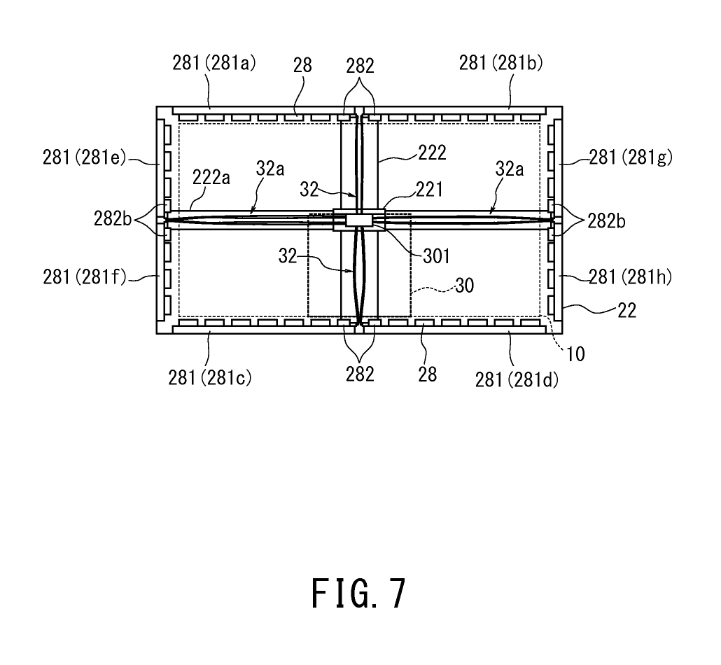

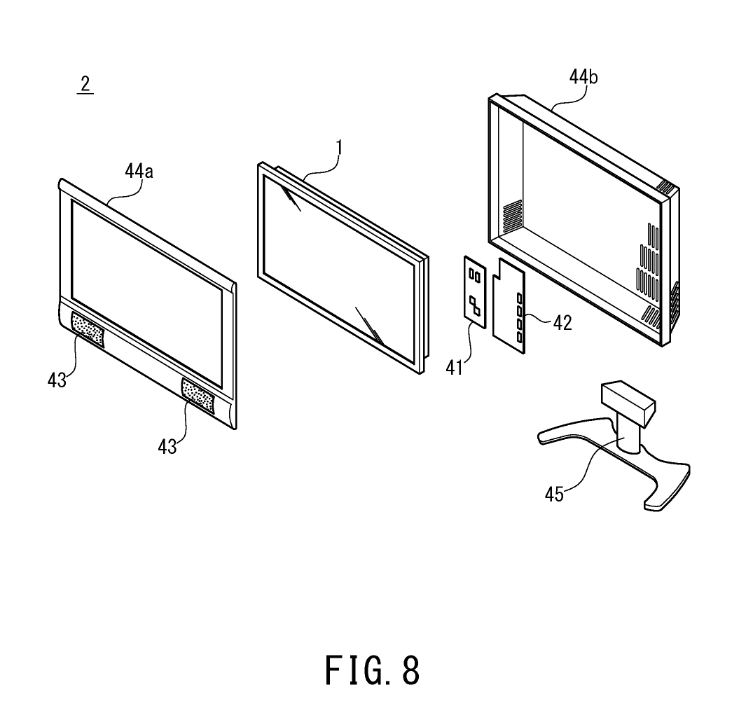

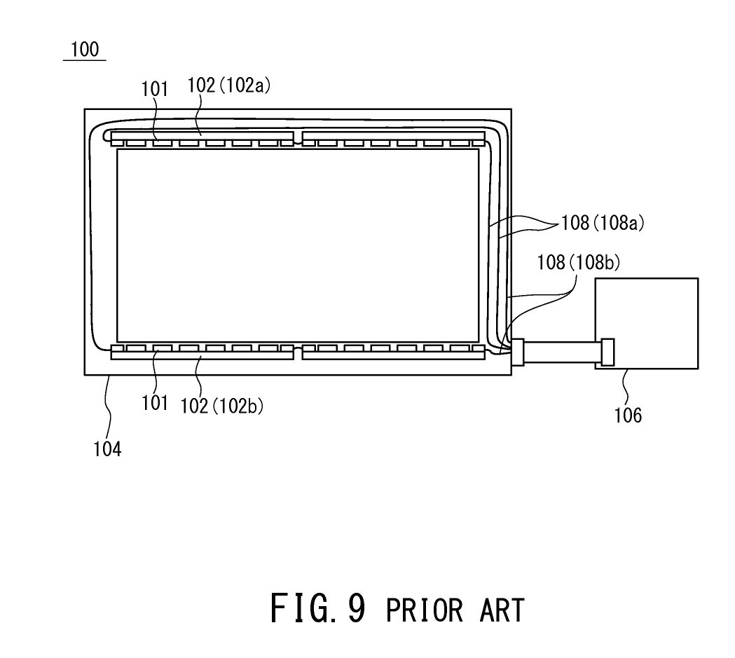

A second modification shown in FIG. 7 has a configuration such that LED light sources 28 (LED boards 281) are disposed along the circumference (the four side faces) of a chassis plate 22 (a liquid crystal display panel 10). That is, the LED light sources 28 are disposed along not only the upper and lower side faces of the chassis plate 22, but also the right and left side faces.

In the second modification, it is preferable that the LED boards 281 (281e to 281h) along the right and left side faces have a configuration such that the two LED boards 281 along the right side face are divided of one LED board and the two LED boards 281 along the left side face are divided of one LED board, as well as the LED boards 281 along the upper and lower side faces. Power supply connectors 282b are disposed at the lower ends of the LED boards 281e and 281g that are disposed on the upper side as facing the liquid crystal display panel 10, and disposed at the upper ends of the LED boards 281f and 281h that are disposed on the lower side as facing the liquid crystal display panel 10.

In addition, it is preferable to provide a concave portion 222a that is disposed along a center line to vertically bisect the chassis plate 22 in addition to a concave portion 222 that is disposed along a center line to horizontally bisect the chassis plate 22. Thus, power supply lines 32a, which are arranged to connect the LED boards 281e to 281h along the right and left side faces of the chassis plate 22 and a power supply board 30, are housed in the concave portion 222a. Thus, the reflection sheet 24 and the light guide plate 25 on the inner bottom face of the chassis plate 22 can be prevented from piggybacking onto the power supply lines 32a.

With this configuration, the length of power supply lines 32 can be reduced in the configuration that the LED light sources 28 are disposed along the circumference of the chassis plate 22. Thus, the reduced length of the power supply lines 32 can decrease an adverse effect of noise caused by or exercised on the power supply lines 32. In addition, the reduced length of the power supply lines 32 can decrease the amount of the power supply lines 32 used in one liquid crystal display device.

It is also preferable that one LED board 281 is disposed along each of the right and left side faces of the chassis plate 22 as described in the first modification (each LED board 281 is not divided into two pieces). In this case, the power supply connectors 282b are disposed in substantial middles of the LED boards 281.

Next, a description of a television receiving device of a preferred embodiment of the present invention will be provided. FIG. 8 is an exploded perspective view showing a schematic configuration of a television receiving device 2 of the present embodiment.

The television receiving device 2 includes the liquid crystal display device 1 of the present embodiment, a tuner 41, an electric power supply 42, loudspeaker units 43, a cabinet 44a, a cabinet 44b, and a supporting member 45 as shown in FIG. 8. A conventional tuner, loudspeaker units, electric power supply, cabinets and supporting member can be used as the tuner 41, the loudspeaker units 43, the electric power supply 42, the cabinet 44a, the cabinet 44b and the supporting member 45, so that brief descriptions thereof are provided instead of detailed descriptions.

The tuner 41 is arranged to produce an image signal and a sound signal of a given channel based on a received radio wave. A conventional terrestrial tuner (analog and/or digital), a BS tuner and a CS tuner are preferably used as the tuner 41. The loudspeaker units 43 are arranged to produce a sound based on the sound signal produced by the tuner 41. Generally-used speakers are preferably used as the loud speaker units 43. The electric power supply 42 is arranged to supply electric power to the display device 1 of the present embodiment, the tuner 41, the loudspeaker units 43 and other components.

The liquid crystal display device 1 of the present embodiment, the tuner 41, the loudspeaker units 43 and the electric power supply 42 are housed in the cabinet 44a and the cabinet 44b, which is supported by the supporting member 45. Shown in FIG. 8 is the configuration that the cabinets define a front side cabinet 44a and a back side cabinet 44b, between which the display device 1, the tuner 41, the loudspeaker units 43 and the electric power supply 42 are housed. Another configuration such that the tuner 41, the loud speaker units 43 and the electric power supply 42 are incorporated in the liquid crystal display device 1 is preferably used.

The foregoing description of the preferred embodiments of the present invention has been presented for purposes of illustration and description with reference to the drawings. However, it is not intended to limit the present invention to the embodiments, and modifications and variations are possible as long as they do not deviate from the principles of the present invention.

For example, the LED light sources 28 and the wires of various kinds that are explained in the above-described embodiment and modifications may be opposite in polarity.

In addition, though explained in the above-described embodiment and modifications is using the LED light sources 28 as the light sources, the technical idea of the present invention can be applied also to an edge light type illuminating device including fluorescent tubes as light sources.

In addition, though explained in the above-described embodiment and modifications is the configuration that the LED light sources 28 disposed along the side faces of the chassis plate are connected in series to each other, the present invention is not limited to this configuration, and the LED light sources 28 can be connected in any manner. For example, it is preferable that a plurality of LED light sources 28 are divided into blocks, where a given number of LED light sources 28 are connected in series to each other in each block, and the blocks are controlled independently from each other (the blocks are connected in parallel).

In addition, though explained in the above-described embodiment and modifications is the configuration that the copper wires are used as the power supply lines, the present invention is not limited to this configuration. For example, copper foil patters are provided on the chassis plate and is used as the power supply lines. Thus, the wiring routes can advantageously have shortest distances without concern for disconnection because of distortion or deformation of wires.

1. An illuminating device comprising:
a chassis plate having a square shape when seen in a plan view;
a light source that is disposed along a side face of the chassis plate; power supply means arranged to supply electric power to the light source; and a connecting connector arranged to electrically connect the power supply means and the light source,
wherein the connecting connector is disposed at a substantial center of the chassis plate.

2. The illuminating device according to claim 1, further comprising a power supply line, one end of which is in connection with the connecting connector.

3. The illuminating device according to claim 2, further comprising a through-hole disposed at the substantial center of the chassis plate,
wherein the light source and the power supply line are disposed on a front side of the chassis plate,
wherein the power supply means arranged to supply electric power to the light source comprises the connecting connector, and is disposed on a back side of the chassis plate, and
wherein the one end of the power supply line is through the through-hole to be in electrical connection with the power supply means via the connecting connector.

4. The illuminating device according to claim 3, wherein the chassis plate comprises a concave portion having the shape of being dented to a face of the chassis plate, the face being opposite to a face on which the light source is disposed, and the power supply line is housed in the concave portion.

5. The illuminating device according to claim 2,
wherein the light source comprises a plurality of LED light sources mounted on each of LED boards that are disposed along two opposing side faces of the chassis plate,
wherein the illuminating device further comprises power supply connectors that are each mounted on the LED boards, each of the power supply connectors comprising:
a positive terminal that is in electrical connection with a positive electrode of the LED light sources; and
a negative terminal that is in electrical connection with a negative electrode of the LED light sources, and
wherein the other ends of the power supply lines are in connection with the power supply connectors.

6. The illuminating device according to claim 5,
wherein the two LED boards on each of which the plurality of LED light sources are mounted are disposed along an upper side face of the chassis plate, and the two LED boards on each of which the plurality of LED light sources are mounted are disposed are disposed along a lower side face of the chassis plate, and
wherein in the LED boards disposed on the right as facing the chassis plate, the power supply connectors are disposed at left ends of the LED boards, and in the LED boards disposed on the left as facing the chassis plate, the power supply connectors are disposed at right ends of the LED boards.

7. The illuminating device according to claim 3, wherein the connecting connector comprises a connector housing, of which an outer surface has a light color.

8. The illuminating device according to claim 2, wherein the power supply line comprises a copper wire.

9. The illuminating device according to claim 2, wherein the power supply line comprises copper foil.

10. The illuminating device according to claim 1, wherein the power supply means comprises a flexible board.

11. The illuminating device according to claim 1, wherein the power supply means comprises a glass epoxy board.

12. The illuminating device according to claim 1, wherein the power supply means comprises a phenolic paper board.

13. The illuminating device according to claim 1, wherein the power supply means comprises an aluminum board.

14. A display device comprising:
the illuminating device according to claim 1; and
a display panel arranged to receive light emitted from the illuminating device.

15. The display device according to claim 14,
wherein the display device comprises a liquid crystal display device, and the display panel comprises a liquid crystal display panel.

16. A television receiving device that comprises the display device according to claim 14.

17. A television receiving device that comprises the liquid crystal display device according to claim 15.
